(19) United States
(12) Patent Application Publication
(10) Pub. No.: US 2020/0411006 A1
(43) Pub. Date: Dec. 31, 2020

(54) TRANSIT VOICE ASSISTANT

(71) Applicant: NJ TRANSIT Corporation, Newark, NJ (US)

(72) Inventors: Faisal JAMEEL, Kendall Park, NJ (US); Saurabh KUMAR, Denville, NJ (US); Jomal A. WILLIAMS, Secaucus, NJ (US); Crystal W. ZHONG, Kendall Park, NJ (US)

(73) Assignee: NJ TRANSIT Corporation, Newark, NJ (US)

(21) Appl. No.: 16/915,636

(22) Filed: Jun. 29, 2020

Related U.S. Application Data
(60) Provisional application No. 62/868,429, filed on Jun. 28, 2019.

(51) Int. Cl. G10L 15/26; G08G 1/123

(52) U.S. Cl. CPC G10L 15/26; G08G 1/123

(57) ABSTRACT

Transit voice assistant is a conversational voice-based assistant, accessible 24 hours a day and 7 days a week. It responds to user's request for real-time transit system information as well as transit alerts. Just say where you want to go to and transit voice assistant will make it happen. Transit voice assistant provides a unique experience for the customer by enabling the user to interact in a more intuitive way using only their voice. Transit voice assistant responds to the way users speak and think, without requiring users to type on a keyboard or screen. Transit voice assistant brings customers new levels of ease and convenience through voice technology, including natural language understanding and automatic speech recognition. The transit voice assistant is constantly learning and improves as more data is collected. Reach and delight more customers, where they are, through millions of voice powered devices.

### CROSS REFERENCE TO RELATED APPLICATIONS

This application claims the benefit of U.S. Patent application No. 62/868,429 filed Jun. 28, 2019 entitled TRANSIT VOICE ASSISTANT, naming inventors Faisal JAMEEL, Saurabh KUMAR, Jomal A. WILLIAMS and Crystal W. ZHONG, which application is incorporated by reference as if fully set forth.

### FIELD OF INVENTION

The present invention is directed to the use of voice in linking to transit activities, and more specifically, to a transit voice assistant.

### BACKGROUND

Ease of access to information has become an increasingly important feature in the transportation industry. Therefore, a need exists for a system that provides access to transit system information via smart devices, such as through voice commands.

### SUMMARY

Transit voice assistant is a conversational voice-based assistant, accessible 24 hours a day and 7 days a week. It responds to user's request for real-time transit system information as well as transit alerts. Just say where you want to go to and transit voice assistant will make it happen. Transit voice assistant provides a unique experience for the customer by enabling the user to interact in a more intuitive way using only their voice. Transit voice assistant responds to the way users speak and think, without requiring users to type on a keyboard or screen. Transit voice assistant brings customers new levels of ease and convenience through voice technology, including natural language understanding and automatic speech recognition as well as machine learning techniques. The transit voice assistant is constantly learning and improves as more data is collected. Reach and delight more customers, where they are, through millions of voice powered devices.

A system and method for providing a voice assistant within a transportation system including a plurality of vehicles is described. The system and method includes a smart receiving device for receiving and recognizing a user input using automatic speech recognition (ASR) for speech to text and natural language understanding (NLU) to recognize the intent of the user input, a service platform that receives the recognized received user input, and a database that contains system information for retrieval by the system platform based on the recognized received user input, the service platform further providing a response to the smart receiving device based on the received system information allowing the smart receiving device to respond to the user.

The system and method of providing a transit voice assistant for a transportation system include recognizing a customer query via a user input using automatic speech recognition (ASR), providing a dialog statement to gain additional information, receiving a user response to the provided dialog statement via a user input, querying real-time track circuit data and schedules from a database, computing trip status based on the queried real-time and schedules, replying using natural language generation with the computed trip status. The system and method may further include providing real-time information, train times, delays and schedules.

The user input may be a voice input, keyboard input or other input that is accepted by the receiving smart device. The user input may be one question of a plurality of questions. The user input may be received via a speaker of the smart device. The smart device may provide voice interaction. The service platform may receive the recognized received user input using JSON with intent and utterance pairs. The system information may include transit information. The retrieval may use an AWS lambda python function to query the database via an API. The response from the database may be an XML response. The system response from the service platform may be delivered in JSON. The smart device may provide real-time information, train times, delays and schedules. The real-time information may include at least one of train departure times, train status, train delays, rail trip planner, train alerts and last train of the day information and similar information for buses and other transportation means. The real-time information may include the time the train is scheduled to reach a destination station, transfer stations, and train stops.

### BRIEF DESCRIPTION OF THE DRAWINGS

A more detailed understanding can be had from the following description, given by way of example in conjunction with the accompanying drawings wherein:

FIG. 1 depicts a transportation system that includes a plurality of buses and a plurality of trains according to the present system;

FIG. 2 illustrates a trip of a train in the system of FIG. 1;

FIG. 3 illustrates the architecture of the present invention;

FIG. 4 illustrates a flow of a dialog architecture for the architecture of FIG. 3;

FIG. 5 illustrates additional features of the present system;

FIG. 6 illustrates a multi-modal interface of the present invention;

FIG. 7 illustrates a multi-modal interface of the present invention;

FIG. 8 illustrates some of the benefits of the present invention in transforming customer experience with voice or alternative inputs;

FIG. 9 illustrates a method performed in the system of FIG. 3; and

FIG. 10 illustrates a diagram of an example device in which one or more portions of one or more disclosed examples may be implemented.

### DETAILED DESCRIPTION

Transit voice assistant is a conversational voice-based assistant, accessible 24 hours a day and 7 days a week. It responds to user's request for real-time transit system information as well as transit alerts. Just say where you want to go to and transit voice assistant will make it happen. Transit voice assistant provides a unique experience for the customer by enabling the user to interact in a more intuitive way using only their voice. Transit voice assistant responds to the way users speak and think, without requiring users to type on a keyboard or screen. Transit voice assistant brings customers new levels of ease and convenience through voice technology, including natural language understanding and automatic speech recognition. The transit voice assistant is constantly learning and improves as more data is collected. With an ever growing repository of transit related human-computer interactions, machine learning techniques can be applied to fine tune the artificial intelligence model and improve accuracy as well as response. Variations in voice tones can be used for communicating different types of transit alerts. Reach and delight more customers, where they are, through millions of voice powered devices.

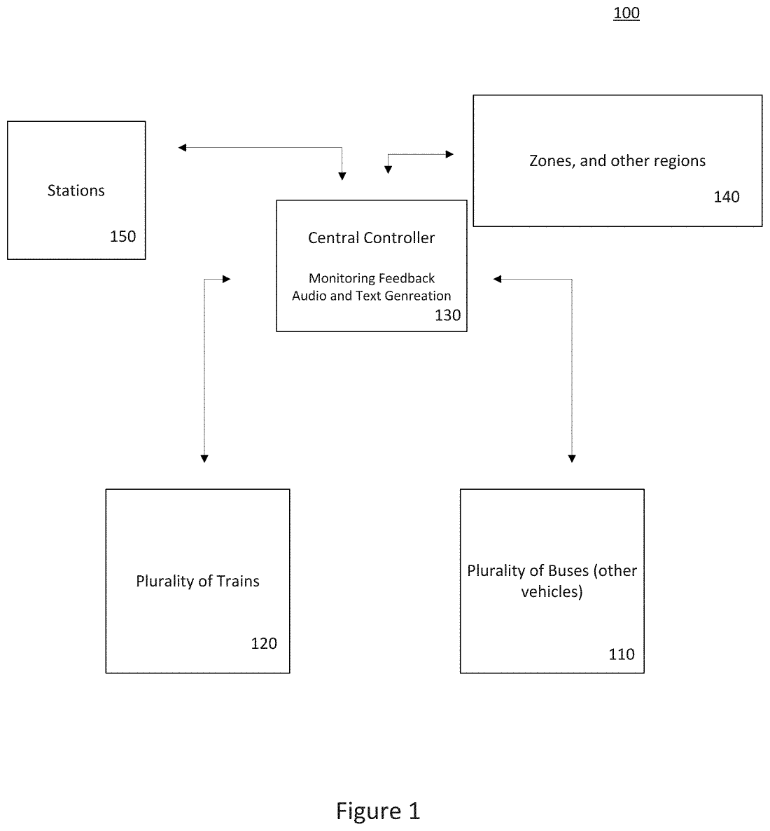

FIG. 1 depicts a transportation system 100 that includes a plurality of buses 110 and a plurality of trains 120 operating between and among a set of stations 150. The system 100 may be designed to be operated at a central location by a central controller 130, or the functions of the central controller 130 at the central location may be divided among a number of different points within the system 100. The central controller 130 functionality may be divided in zones or regions of coverage 140, for example, and the regions of coverage may communicate with one another. Such a divided system may allow for segregation of certain functions within the system 100. The system 100 may include feedback taking the form of line and/or track circuit, GPS data, and other real-time data provided on the vehicles within the present system 100.

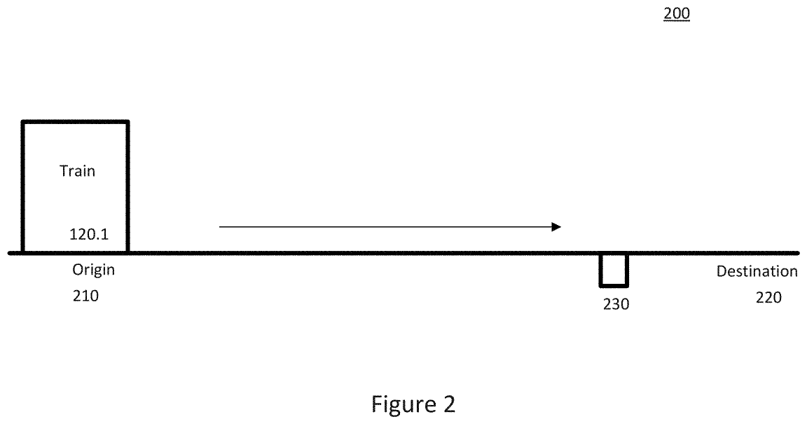

Referring now additionally to FIG. 2, there is illustrated trip 200 of a train 120.1. Train 120.1 may be one of the plurality of trains 120, for example. While a single trip 200 is depicted in FIG. 2, any number of trips may be monitored. The number of trips may be in the hundreds, thousands, or more in a given day.

System 100 relies on real-time data for each specific trip 200. For example, train 120.1 has an origin 210 and destination 220 which defines the trip 200. The trip 200 may be defined before it occurs. That is, the starting point, or origin 210, and time and the ending point, or destination 220, and time are known. Before, during and after the trip 200, real-time data for the trip 200 and current status of the train 120.1 are fed into the system 100. System 100 receives estimated time of arrival (ETA) data. The data may be presented as the number of seconds the train 120.1 is late as determined from the track circuit 230 on which the train 120.1 travels. This ETA is mixed in with additional data, including manual data, for example, if applicable, to calculate the estimated arrival time in minutes. This calculation is performed regularly during the trip, such as every second throughout the trip 200, for example This data is used to monitor the trip 200 determine future information about that trip 200 when the trip 200 reoccurs in the future. The system 100 also uses various types of real-time data to calculate the current status of the trip 200. Real-Time data may be based on many different factors. For instance, train 120.1 may pass over a track circuit 230 having a fixed location on the track. When this event occurs, a signal may be sent from the track circuit 230 to the centralized controller 130 to indicate the train 120.1 passed over the track circuit 230. This signal may include timing information to indicate the exact timing of the train 120.1 interacting with the track circuit 230. Given the fixed location of the track circuit 230, and the time, the real-time data can be used to derive the current state of the trip 200. The system 100 can calculate the current state of the trip 200 based upon one or more real-time events associated with the trip 200 or real-time events associated with trips that affect a given trip. While this example is directed to a single train 120.1 and a single track circuit 230 that is tripped while the train 120.1 proceeds from the origin 210 to the destination 220, this information is collected on each of the plurality of trains 120 and the plurality of buses 110 as the trains and buses perform their daily routes. The track circuit 230 may be prevalent within the system 100, such as placed periodically on tracks and routes to provide constant feedback of the location of the plurality of trains 120 and plurality of buses 110, for example. Additionally other forms of feedback may also be monitored.

System 100 has been described to provide an understanding of where elements within system 100 are located at a given time, when they will arrive at certain locations, and the like (collectively termed “status”). This status generally provides the underlying data for informing users of system 100 of information regarding the current status. Users may be informed by system 100 providing messages regarding the status of elements of the system 100. In addition, this status provides the trigger of when to provide the messages regarding the status.

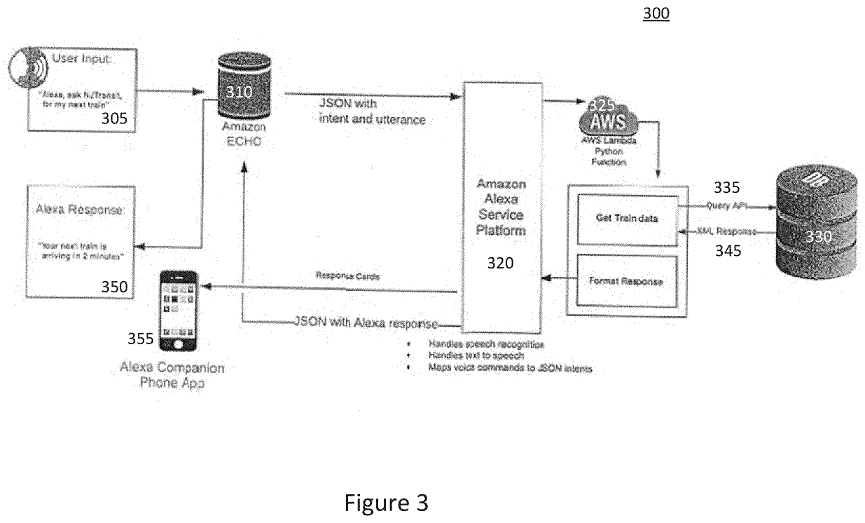

FIG. 3 illustrates the architecture 300 of the present invention. As illustrated, there is a user input 305. This input 305 may be a voice input, keyboard input or other input that is accepted by the receiving smart device 310. This input 305 as will be discussed herein can include a variety of questions. One such question, by way of example, may include “Ask NJTransit for my next train.”

This user input 305 is received by a smart device 310 via a speaker, for example. The smart device 310 may take the form of an Amazon Echo, also referred to as an Echo and known colloquially as “Alexa.” Other smart devices 310 via applications on smartphones, or other known devices may also be used. These smart devices 310 connect to a voice-controlled intelligent personal assistant service. Generally, smart device 310 provides voice interaction, in addition to providing weather, traffic and other real-time information. The smart device 310 may also control several other smart devices, acting as a home automation hub.

The smart device 310 receives and recognizes the user input 305 using automatic speech recognition (ASR) for speech to text and natural language understanding (NLU) to recognize the intent of the input 305. The smart device 310 may also use machine learning (ML) and artificial intelligence (AI)).

The intent of the input is then sent to the service platform 320. In the case that the smart device 310 is an Alexa device, the service platform 320 may be an Amazon Alexa Service Platform. The intent of the input may be sent in any acceptable computer language. One example is to use JSON with intent and utterance pairs. JSON refers to JavaScript Object Notation (JSON) which is an open-standard file format that uses human-readable text to transmit data objects consisting of attribute—value pairs and array data types (or any other serializable value) often for asynchronous browser—server communication. In this case the intent and utterance may be paired.

The service platform 320, upon receipt on the converted user input 305, retrieves the system information, such as the train information. This retrieval may occur using an AWS lambda python function 325 to query the database 330 via an API 335. AWS lambda 325 is an event-driven, server less computing platform that runs code in response to events, i.e., the user input 305, and automatically manages the computing resources required by that code.

The API 335 is an application programming interface that includes is a set of subroutine definitions, communication protocols, and tools. In general terms, it is a set of clearly defined methods of communication among various components. In the present system 300, the API 335 allows the service platform 320 to query the database 330 to get system information, such as the train information, for example. The response 345 from the database may be in the form of an XML response, for example.

The service platform 320 then provides a response to the smart device 310 based on the received system information allowing the smart device 310 to respond to the user 350. This response may be delivered in JSON as appropriate. For example, the smart device 310 may say “Your next train is arriving in 2 minutes.” The service platform 320 may also provide the system information to a phone application 355 or other method of conveying the information to the user who queried the system with the user input 305. The service platform 320 may handle speech recognition, text to speech and map voice commands to JSON intents as necessary.

The voice driven smart device 310 may instead provide for inputs 305 in other ways, such as by typing for example or by interacting with the screen in other ways. The smart device 310 may ease the daily commute with real-time information, train times, delays and schedules. The real-time information may include, by way of example only, train departure times, train status, train delays, rail trip planner, train alerts and last train of the day information and similar information for buses and other transportation means. This may include the time the train is scheduled to reach a destination station, transfer stations, and train stops.

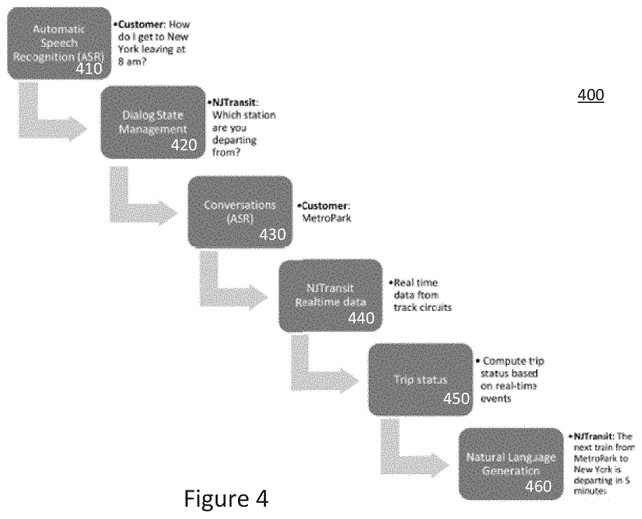

FIG. 4 illustrates a flow 400 of a dialog architecture for the architecture of FIG. 3. As illustrated in FIG. 4, automatic speech recognition (ASR) 410 is used to recognize the customer query (user input 305) of “How do I get to New York leaving at 8 am?” A dialog statement 420 is provided to gain additional information. The system 300 via smart device 310 responds “Which station are you departing from?” Using the conversation ASR 430, the customer responds “MetroPark.” The system 300 queries real-time track circuit data and schedules 440 from the database 330, and computes trip status 450 based on real-time and schedules events 440, then replies using natural language generation 460 via smart device 310 that “The next train from MetroPark to New York is departing in 5 minutes.”

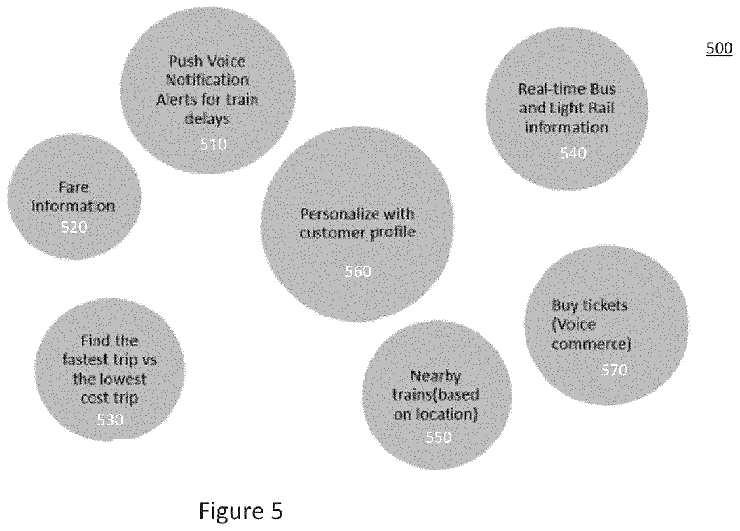

FIG. 5 illustrates additional features 500 of the system. These features 500 include push voice notification alerts for delays 510, fare information 520, fastest trip and lowest cost trip 530, real-time bus and light tail information 540, nearby trains based on location 550, and personalization 560 with customer profile including home and work, and common commuting trips. The present system also provides for access in multiple languages. There may be alerts for specific lines based on profile information. Information may be based on location, such as nearby trains and destinations, or based on profile, including common or pre-entered destinations. Information may also be provided on the first trip of the next day. Additionally, the system 300 may include a wallet and the ability to add money or tickets to the wallet, or separate from a wallet the ability to buy tickets 570. The wallet and purchase functions may be linked with a gateway that allows for the functional and connection to a payment system.

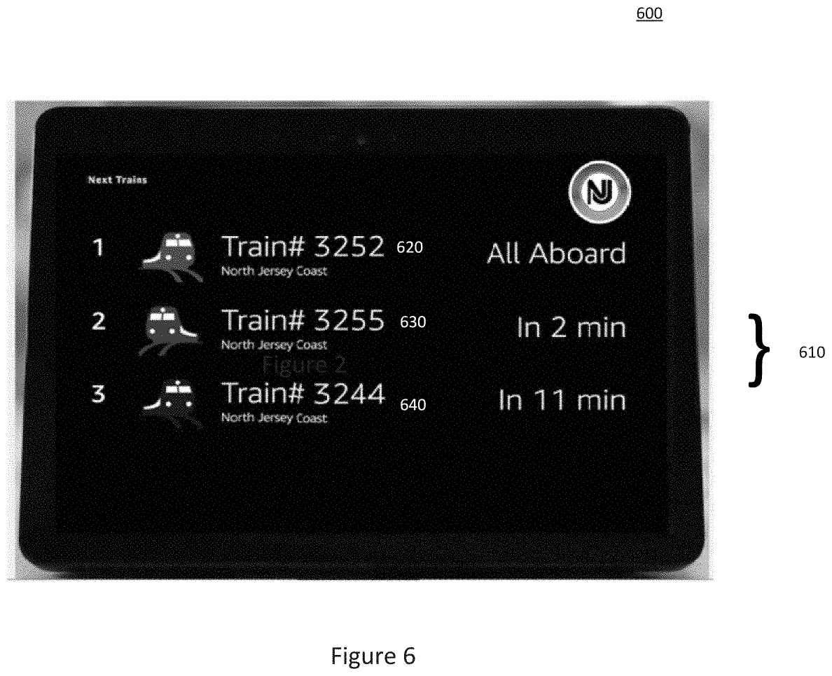

FIG. 6 illustrates a multi-modal interface 600 of the present invention. As illustrated in FIG. 6, there is shown an Echo Show with a display of the user interface 305. In the user interface 305 there is a series of listed trains 610 that are next to depart. The first train 620 is loading passengers, the second train 630 is arriving in 2 minutes and the third train 640 is arriving in 11 minutes.

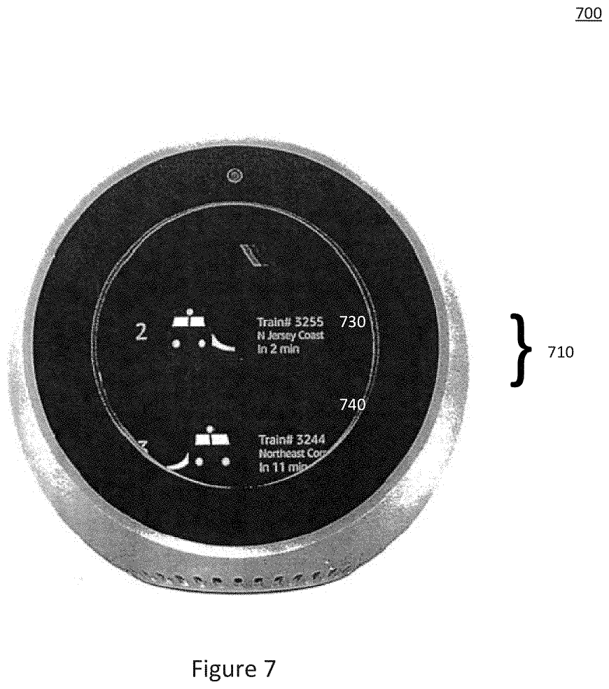

FIG. 7 illustrates a multi-modal interface 700 of the present invention. As illustrated in FIG. 7 there is shown an Echo Spot with a display of the user interface 305. Similar to FIG. 6, in the user interface 305 there is a series of listed trains 710 that are next to depart. The first train (not shown) is loading passengers, the second train 730 is arriving in 2 minutes and the third train 740 is arriving in 11 minutes.

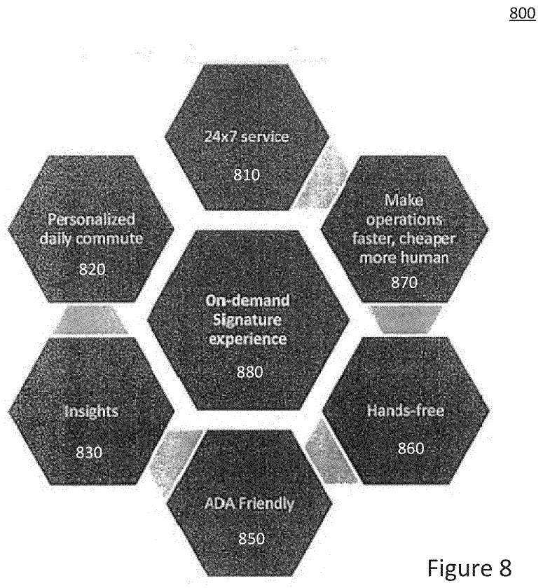

FIG. 8 illustrates some of the benefits 800 of the present invention in transforming customer experience with voice or alternative inputs. The present invention provides 24 hours a day and 7 day a week access 810, a personalized daily commute 820, insights 830, ADA friendly access 850, hands-free access 860, making operations faster, cheaper and more human 870, and providing an on-demand signature experience 880. Voice-enabled experiences may be the ubiquitous expectation and can add value to a business. The smart device 310 may integrate with cloud based services like AWS 325 to build end-to-end enterprise voice solutions. Building engaging user experiences and conversational interactions. Additionally, insights may be considered for improving customer service based on data analytics in the present system 300.

The present system 300 may reduce the number of unanswered calls to the call center and save on WR costs. The present system 300 may provide multi-channel marketing opportunities. Display advertisements may be provided and video, images or text may be included. Voice based advertisements may also be utilized.

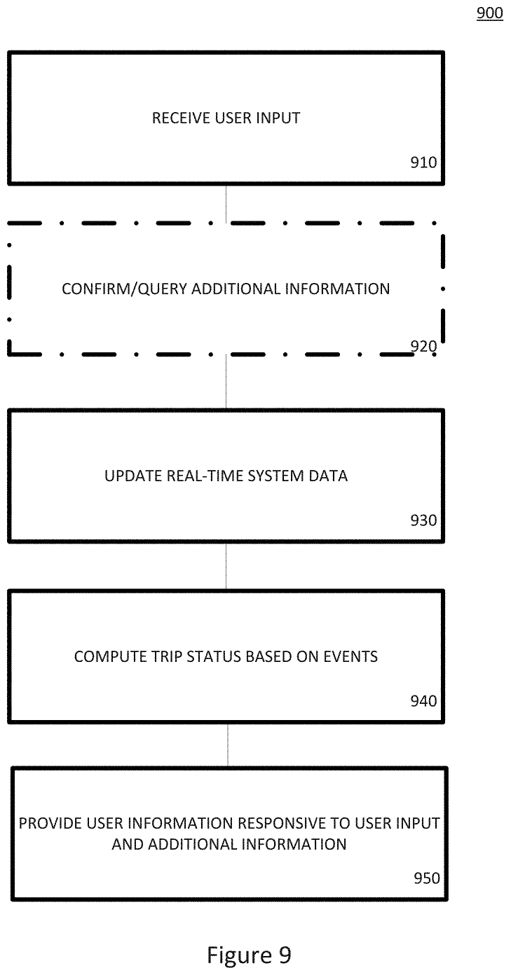

FIG. 9 illustrates a method 900 performed in the system of FIG. 3. Method 900 includes, at step 910, receiving a user input. At step 920, method 900 may include confirming and/or querying the user or system for additional information. At step 930, method 900 includes updating real-time system data. At step 940, method 900 includes computing trip status based on events occurring within system 300. At step 950, method 900 providing the user information responsive to the user input and additional information.

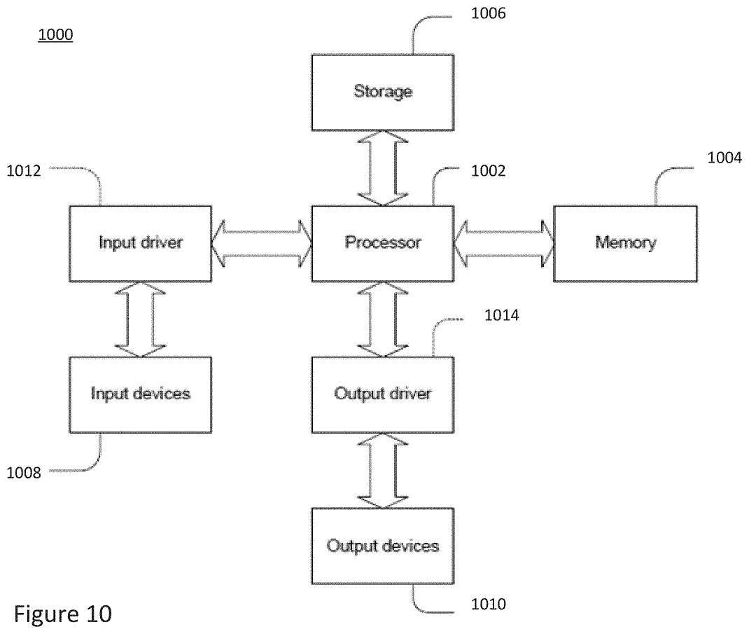

FIG. 10 illustrates a diagram of an example device 1000 in which one or more portions of one or more disclosed examples may be implemented. The device 1000 may include, for example, a head mounted device, a server, a computer, a gaming device, a handheld device, a set-top box, a television, a mobile phone, or a tablet computer. The device 1000 includes a compute node or processor 1002, a memory 1004, a storage 1006, one or more input devices 1008, and one or more output devices 1010. The device 1000 may also optionally include an input driver 1012 and an output driver 1014. It is understood that the device 1000 may include additional components not shown in FIG. 10.

The compute node or processor 1002 may include a central processing unit (CPU), a graphics processing unit (GPU), a CPU and GPU located on the same die, or one or more processor cores, wherein each processor core may be a CPU or a GPU. The memory 1004 may be located on the same die as the compute node or processor 1002, or may be located separately from the compute node or processor 1002. The memory 1004 may include a volatile or non-volatile memory, for example, random access memory (RAM), dynamic RAM, or a cache.

The storage 1006 may include a fixed or removable storage, for example, a hard disk drive, a solid state drive, an optical disk, or a flash drive. The input devices 1008 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 1010 may include a display, a speaker, a printer, a haptic feedback device, one or more lights, an antenna, or a network connection (e.g., a wireless local area network card for transmission and/or reception of wireless IEEE 802 signals).

The input driver 1012 communicates with the compute node or processor 1002 and the input devices 1008, and permits the compute node or processor 1002 to receive input from the input devices 1008. The output driver 1014 communicates with the compute node or processor 1002 and the output devices 1010, and permits the processor 1002 to send output to the output devices 1010. It is noted that the input driver 1012 and the output driver 1014 are optional components, and that the device 1000 will operate in the same manner if the input driver 1012 and the output driver 1014 are not present.

In general and without limiting embodiments described herein, a computer readable non-transitory medium including instructions which when executed in a processing system cause the processing system to execute a method for load and store allocations at address generation time.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system for providing a voice assistant within a transportation system including a plurality of vehicles, the system comprising:
a smart receiving device for receiving and recognizing a user input using automatic speech recognition (ASR) for speech to text and natural language understanding (NLU) to recognize the intent of the user input;
a service platform that receives the recognized received user input; and
a database that contains system information for retrieval by the system platform based on the recognized received user input;
the service platform further providing a response to the smart receiving device based on the received system information allowing the smart receiving device to respond to the user.

2. The system of claim 1, where the user input is a voice input, keyboard input or other input that is accepted by the receiving smart device.

3. The system of claim 1, wherein the user input is one question of a plurality of questions.

4. The system of claim 1, wherein the user input received via a speaker of the smart device.

5. The system of claim 1, wherein the smart device provides voice interaction.

6. The system of claim 1, wherein the service platform receives the recognized received user input using JSON with intent and utterance pairs.

7. The system of claim 1, wherein the system information includes transit information.

8. The system of claim 1, wherein the retrieval uses an AWS lambda python function to query the database via an API.

9. The system of claim 1, wherein the response from the database is an XML response.

10. The system of claim 1, wherein the system response from the service platform is delivered in JSON.

11. The system of claim 1, wherein the smart device provides real-time information, train times, delays and schedules.

12. The system of claim 11, wherein the real-time information includes at least one of train departure times, train status, train delays, rail trip planner, train alerts and last train of the day information and similar information for buses and other transportation means.

13. The system of claim 11, wherein the real-time information includes the time the train is scheduled to reach a destination station, transfer stations, and train stops.

14. A method of providing a transit voice assistant for a transportation system, the method comprising:
recognizing a customer query via a user input using automatic speech recognition (ASR);
providing a dialog statement to gain additional information;
receiving a user response to the provided dialog statement via a user input;
querying real-time track circuit data and schedules from a database;
computing trip status based on the queried real-time and schedules;
replying using natural language generation with the computed trip status.

15. The method of claim 14, wherein the user input is a voice input, keyboard input or other input that is accepted by the receiving smart device.

16. The method of claim 14, wherein the user input is received via a speaker of the smart device.

17. The method of claim 14, wherein the smart device provides voice interaction.

18. The method of claim 14, further comprising providing real-time information, train times, delays and schedules.

19. The method of claim 18, wherein the real-time information includes at least one of train departure times, train status, train delays, rail trip planner, train alerts and last train of the day information and similar information for buses and other transportation means.

20. The method of claim 18, wherein the real-time information includes the time the train is scheduled to reach a destination station, transfer stations, and train stops.
